(19) United States
(12) Patent Application Publication
(10) Pub. No.: US 2016/0126639 A1
(43) Pub. Date: May 5, 2016

(54) COIL STRUCTURE AND WIRELESS POWER RECEIVING APPARATUS INCLUDING THE SAME

(71) Applicant: Samsung Electro-Mechanics Co., Ltd., Suwon-si (KR)

(72) Inventors: Choon Hee Kim, Suwon-Si (KR); Hyun Keun Lim, Suwon-Si (KR); Ki Won Chang, Suwon-Si (KR); Hyung Wook Cho, Suwon-Si (KR); Isaac Nam, Suwon-Si (KR)

(73) Assignee: Samsung Electro-Mechanics Co., Ltd., Suwon-si (KR)

(21) Appl. No.: 14/878,465

(22) Filed: Oct. 8, 2015

(30) Foreign Application Priority Data
Oct. 14, 2014 (KR) 10-2014-0138595
Nov. 7, 2014 (KR) 10-2014-0154800
Dec. 22, 2014 (KR) 10-2014-0186336

(51) Int. Cl. H01Q 21/28; H04W 4/00; H04B 5/00; H01Q 7/00; H02J 5/00

(52) U.S. Cl. CPC H01Q 21/28; H01Q 7/00; H02J 5/005; H04B 5/0037; H04W 4/008

(57) ABSTRACT

A coil structure includes a first coil configured to transmit or receive a first signal of a first frequency, and a second coil configured to transmit or receive a second signal of a second frequency. The second coil is disposed outside the first coil, and a ratio of the second frequency to the first frequency is at least 1.3:1

### CROSS-REFERENCE TO RELATED APPLICATION(S)

This application claims the benefit under 35 USC 119(a) of Korean Patent Application Nos. 10-2014-0138595 filed on Oct. 14, 2014, 10-2014-0154800 filed on Nov. 7, 2014, and 10-2014-0186336 filed on Dec. 22, 2014, in the Korean Intellectual Property Office, the entire disclosures of which are incorporated herein by reference for all purposes.

### BACKGROUND

1. Field

This application relates to a coil structure and a wireless power receiving apparatus including the same.

2. Description of Related Art

In accordance with the development of wireless technology, various wireless functions ranging from the transmission of data to the transmission of power have been implemented.

For both the transmission of data and the transmission of power, coils are used. In this regard, power is provided wirelessly or data is transmitted using a magnetic field induced between a pair of coils.

Meanwhile, a mobile terminal to which the wireless power transmission technology is applied may use additional coils, in addition to coils for wirelessly transmitting power. Therefore, several coils may be used in a single mobile terminal, which may cause problems in which interference between the coils occurs and an amount of space required for disposing several coils is increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil structure includes a first coil configured to transmit or receive a first signal of a first frequency; and a second coil configured to transmit or receive a second signal of a second frequency; wherein the second coil is disposed outside the first coil; and a ratio of the second frequency to the first frequency is at least 1.3:1.

The first coil may be a power receiving coil configured to operate at a frequency within a 100 kHZ to 275 kHz band; and the second coil may be a wireless communications coil configured to operate at a frequency within 60 kHZ to 80 kHZ band.

The first coil may include a plurality of windings; and a radius of curvature of an outermost winding of the first coil may be greater than a radius of curvature of an innermost winding of the first coil.

The first coil may be spaced apart from the second coil by a distance of 2 mm to 6 mm.

A number of windings of the first coil may be larger than a number of windings of the second coil.

The first coil may have 10 to 14 windings; the second coil may have 7 to 9 windings; and a distance between the windings of each of the first coil and the second coil may be 0.05 mm to 2 mm.

The first coil may have a first axis having a length of 27 mm to 50 mm, and a second axis having a length of 27 mm to 100 mm; and the second coil may have a first axis having a length of 36 mm to 60 mm, and a second axis having a length of 36 mm to 120 mm.

The first coil may have an inductance of 7.5 μH to 9.5 μH; and the second coil may have an inductance of 10 μH to 12 μH.

The first coil may have a line width of 0.55 mm to 0.7 mm; and the second coil may have a line width of 0.2 mm to 0.5 mm.

The coil structure may further include a third coil disposed outside the first coil and the second coil; and the third coil may be configured to support wireless communications in a near field communication (NFC) scheme.

In another general aspect, a wireless power receiving apparatus includes a first coil configured to operate as a power receiving coil and a wireless communications coil, the first coil being configured to receive a signal of a first frequency as the power receiving coil, and transmit or receive a signal of a second frequency as the wireless communications coil; and a second coil configured to transmit or receive a signal of a third frequency different from the first frequency and the second frequency; wherein at least part of the second coil is disposed outside the first coil.

The wireless power receiving apparatus may further include a power receiving unit configured to wirelessly receive power using the first coil; a wireless communications unit configured to wirelessly transmit or receive data using the first coil; and a switch configured to selectively connect the first coil to the power receiving unit to enable the power receiving unit to wirelessly receive power using the first coil, and selectively connect the first coil to the wireless communications unit to enable the wireless communications unit to wirelessly transmit or receive data using the first coil.

The switch may be further configured to connect the first coil to the power receiving unit as a default setting.

The wireless power receiving apparatus may further include a driver circuit connected to the first coil; a power receiving unit; a wireless communications unit; and a switch configured to selectively connect the driver circuit to the power receiving unit to enable the power receiving unit to wirelessly receive power using the driver circuit and the first coil, and selectively connect the driver circuit to the wireless communications unit to enable the wireless communications unit to wirelessly transmit or receive data using the driver circuit and the first coil.

The second coil may have a same size as the first coil; and a distance between a center of the first coil and a center of the second coil may be at least 60% of a height of the first coil.

The first coil may be configured to operate as the power receiving coil at a frequency within a 100 kHZ to 275 kHz band; and the second coil may be a wireless communications coil configured to operate at a frequency within a 60 kHZ to 80 kHZ band.

Other features and aspects will be apparent from the following detailed description, the drawings, and the claims.

### BRIEF DESCRIPTION OF THE DRAWINGS

FIG. 1 is a perspective view illustrating an example in which a mobile terminal is wirelessly charged with power.

FIG. 2 is a perspective view illustrating an example in which data is transmitted wirelessly by a mobile terminal.

FIG. 3 is a view illustrating an example of a wireless power receiving apparatus.

FIG. 4 is a view illustrating another example of a wireless power receiving apparatus.

FIGS. 5 through 13C are views illustrating examples of coil structures.

FIGS. 14A through 14D are views illustrating examples of different degrees of overlap of a power receiving coil and a wireless communications coil having the same size.

FIG. 15 is a graph illustrating an example of a transmission efficiency according to the degrees of overlap of FIGS. 14A through 14D.

FIG. 16 is a graph illustrating an example of a transmission efficiency of the power receiving coil and the wireless communications coil versus frequency in a case in which the power receiving coil and the wireless communications coil are completely overlapped with each other as illustrated in FIG. 14A.

FIGS. 17A through 17D are views illustrating examples of different degrees of overlap of a power receiving coil and a wireless communications coil having different sizes.

FIG. 18 is a graph illustrating an example of a transmission efficiency according to the degrees of overlap of FIGS. 17A through 17D.

FIG. 19 is a graph illustrating an example of a transmission efficiency of the power receiving coil and the wireless communications coil versus frequency in a case in which the power receiving coil is disposed completely inside the wireless communications coil as illustrated in FIG. 17A.

FIGS. 20A through 20C are views illustrating examples of a distance between the power receiving coil and the wireless communications coil.

FIGS. 21 through 23 are graphs illustrating examples of a relative degree of transmission efficiency versus frequency for the examples of FIGS. 20A through 20C.

FIG. 24 is a perspective view illustrating an example of a cover for a mobile terminal.

FIG. 25 is an exploded perspective view of the cover for the mobile terminal illustrated in FIG. 24.

FIG. 26 is a perspective view illustrating an example of a mobile terminal.

FIG. 27 is an exploded perspective view of the mobile terminal illustrated in FIG. 26.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

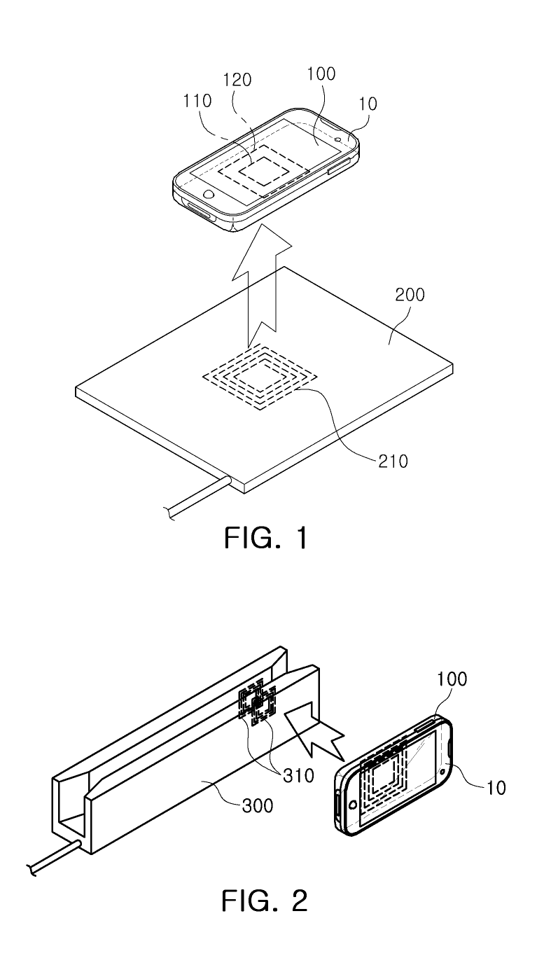

FIG. 1 is a perspective view illustrating an example in which a mobile terminal is wirelessly charged with power.

In the example illustrated in FIG. 1, a wireless power receiving apparatus 100 receives power wirelessly transmitted by a wireless power transmitting apparatus 200 and provides the received power to a mobile terminal 10.

The wireless power receiving apparatus 100 receives power from the wireless power transmitting apparatus 200 wirelessly, in a non-contact manner, using a power receiving coil 110. The power receiving coil 110 resonates with a transmitting coil 210 of the wireless power transmitting apparatus 200 and receives power wirelessly.

The wireless power transmitting apparatus 200 and the wireless power receiving apparatus 100 are not limited to using a specific wireless charging standard. For example, the wireless power transmitting apparatus 200 and the wireless power receiving apparatus 100 may be operated using a wireless charging standard using separate local area wireless communications, such as the A4WP standard. Alternatively, the wireless power transmitting apparatus 200 and the wireless power receiving apparatus 100 may be operated using wireless charging standards that do not use separate local area wireless communications, such as the WPC and PMA standards.

FIG. 2 is a perspective view illustrating an example in which data is transmitted wirelessly by a mobile terminal.

In the example illustrated in FIG. 2, the wireless power receiving apparatus 100 of the mobile terminal 10 transmits data (e.g., data corresponding to card information, etc.) to a wireless communications apparatus 300 in a non-contact manner using a wireless communications coil 120.

In on example, the wireless communications apparatus 300 is a magnetic card reader. The magnetic card reader obtains card information according to a magnetic recognition scheme.

In a case of a general magnetic card, a magnetic strip of the magnetic card is magnetically coupled to a coil 310 included in the wireless communications apparatus 300, and the magnetic card reader obtains the card information from the magnetic strip using the magnetic interface.

Therefore, the magnetic card reader includes a magnetic coupling enabled coil 310, and, in this example, the wireless communications coil 120 of the wireless power receiving apparatus 100 is magnetically coupled to the coil 310 of the magnetic card reader to transmit data.

For instance, the wireless communications coil 120 of the wireless power receiving apparatus transmits the data through magnetic coupling with the coil 310 of the magnetic card reader. To this end, the wireless power receiving apparatus 100 transmits the data from the magnetic card reader by sequentially transmitting wireless communications signals corresponding to the data using the wireless communications coil 120.

In another example, the wireless communications apparatus 300 supports a predetermined standard for wirelessly receiving data using local area communications. For example, the wireless communications apparatus 300 and the wireless communications coil 120 of the wireless power receiving apparatus 100 wirelessly transmit and receive information using a local area wireless communications standard, such as a near field communications (NFC) standard or any other local area wireless communications standard known to one of ordinary skill in the art.

Although FIGS. 1 and 2 illustrate a case in which the power receiving coil 110 is disposed inside the wireless communications coil 120, this is merely illustrative. Hereinafter, various examples of the power receiving coil 110 and the wireless communications coil 120 will be described in more detail.

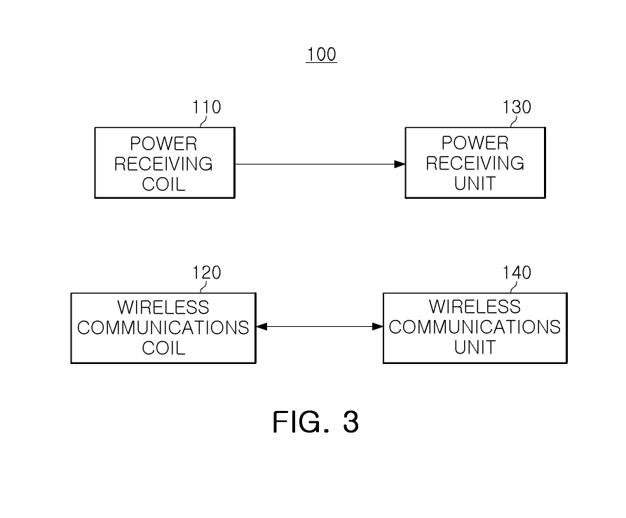

FIG. 3 is a view illustrating an example of a wireless power receiving apparatus 100.

Referring to FIGS. 1 through 3, the wireless power receiving apparatus 100 includes a power receiving coil 110, a power receiving unit 130, a wireless communications coil 120, and a wireless communications unit 140.

The power receiving coil 110 is magnetically coupled to the wireless power transmitting apparatus 200 to receive power wirelessly.

The power receiving unit 130 receives power from the power receiving coil 110.

The wireless communications coil 120 is interfaced with a communications coil of the wireless communications apparatus 300 to perform wireless communications.

The wireless communications unit 140 receives data from and transmits data to the wireless communications coil 120.

In one example, the wireless communications coil 120 interfaces with the receiving coil 310 to read data stored on the magnetic strip of the magnetic card. For instance, the wireless communications coil 120 operates at a first frequency adjacent to a second frequency of the receiving coil 310 of the magnetic reader. For example, the wireless communications coil 120 is operated within the 60 kHZ to 80 kHZ band.

In one example, the wireless communications unit 140 controls the transmission of data by being magnetically coupled to the receiving coil of the magnetic reader. As described above, the magnetic reader includes the receiving coil 310 magnetically coupled to the magnetic strip of the magnetic card, and when the magnetic strip passes near the receiving coil 310, data recorded on the magnetic strip is provided to the receiving coil 310 through magnetic coupling. Thus, the wireless communications unit 140 performs controlling to sequentially transmit information (e.g., the card information) stored on the magnetic strip of the magnetic card. Thus, the magnetic reader receives the sequentially transmitted information just like it would by reading the magnetic card.

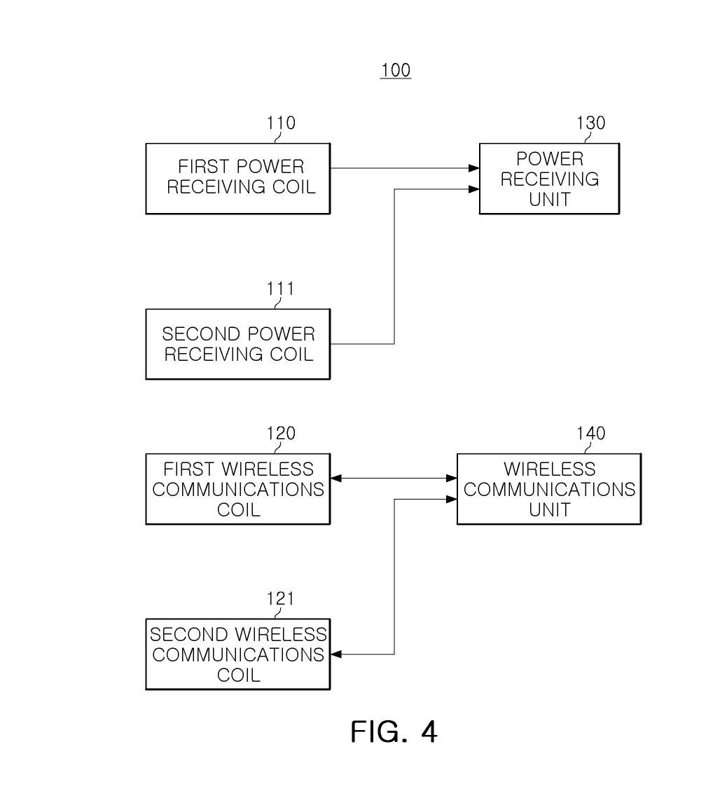

FIG. 4 is a view illustrating another example of a wireless power receiving apparatus 100.

The example illustrated in FIG. 4 illustrates the wireless power receiving apparatus 100 including a plurality of power receiving coils 110 and 111 and a plurality of wireless communications coils 120 and 121.

The plurality of power receiving coils 110 and 111 may use the same wireless power communications standard or may use different wireless power communications standards.

The plurality of wireless communications coils 120 and 121 use different wireless communications standards.

Although the example illustrated in FIG. 4 illustrates an example in which two power receiving coils 110 and 111 and two wireless communications coils 120 and 121 are included, this is merely illustrative. Thus, at least one of the power receiving coils (110, 111) and the wireless communications coil (120, 121) may be provided as a single coil. Alternatively, at least one of the power receiving coils (110, 111) and the wireless communications coil (120, 121) may be provided as three or more coils.

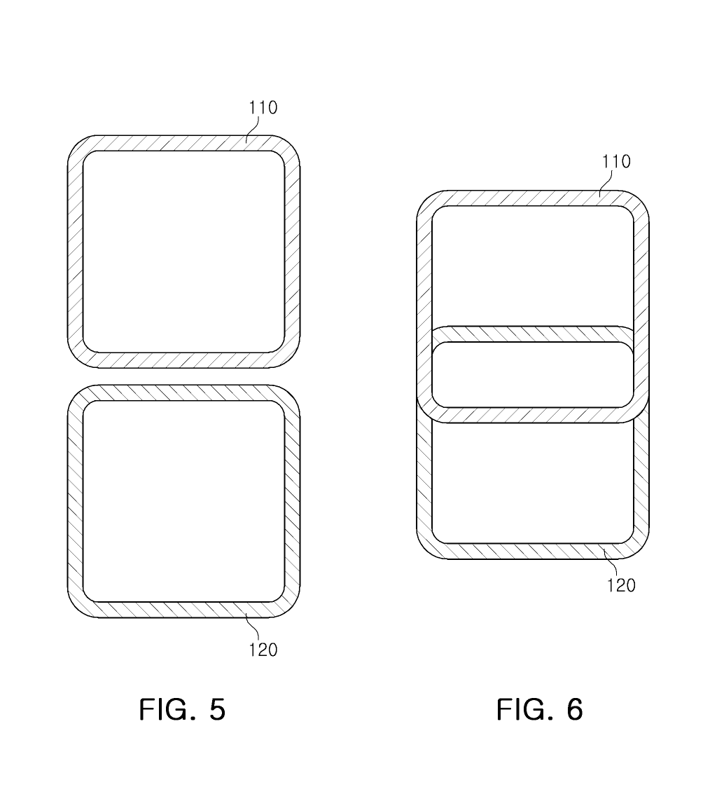

FIGS. 5 through 13C are views illustrating examples of coil structures that are constituted by the power receiving coil and the wireless communications coil.

FIG. 5 illustrates the power receiving coil 110 and the wireless communications coil 120 in a state of separation from each other. The example illustrated in FIG. 5 may be applied in a case in which the power receiving coil 110 and the wireless communications coil 120 influence each other. For example, in a case in which the power receiving coil 110 and the wireless communications coil 120 are operated in a similar frequency band, in order to prevent interference between the power receiving coil 110 and the wireless communications coil 120, a structure of FIG. 5 separating two coils from each other is applied.

FIG. 6 illustrates an example in which the power receiving coil 110 and the wireless communications coil 120 are overlapped with each other at least partially. The example illustrated in FIG. 6 may be applied in a case in which a degree of mutual influence of the power receiving coil 110 and the wireless communications coil 120 is relatively low, and a size of the overlapped region of the power receiving coil 110 and the wireless communications coil 120 may be changed depending on the influence between the power receiving coil 110 and the wireless communications coil 120.

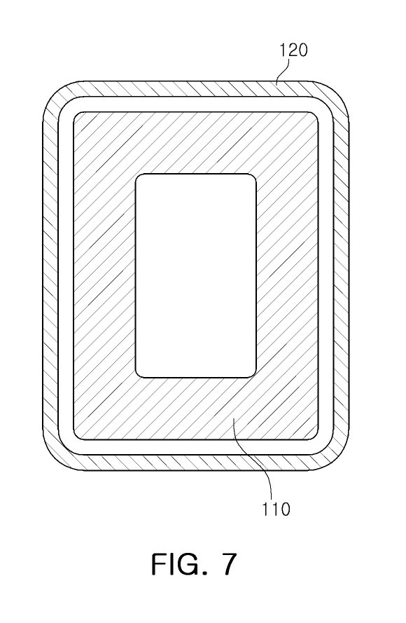

FIG. 7 illustrates an example in which one of the power receiving coil 110 and the wireless communications coil 120 is disposed inside the other one. The example illustrated in FIG. 7 may be applied in a case in which the influence between the power receiving coil 110 and the wireless communications coil 120 is weak.

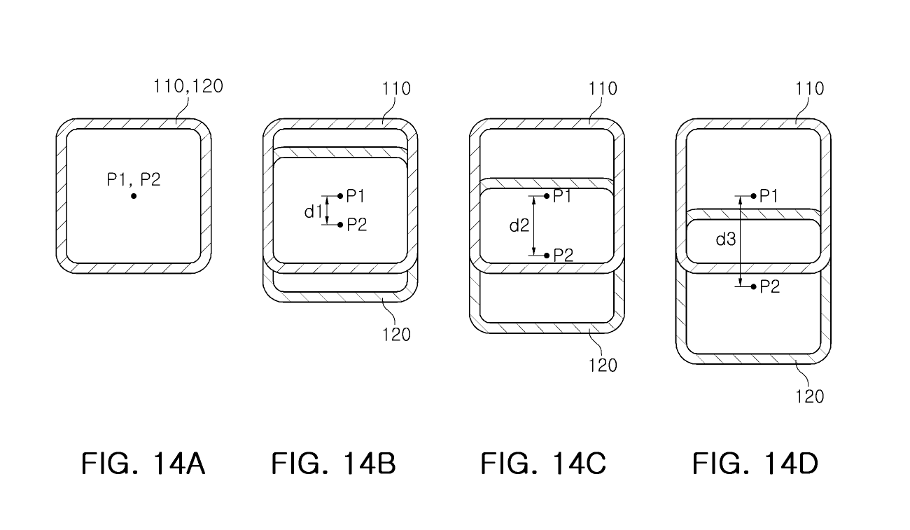

The coil structures illustrated in FIGS. 5 through 7 may be selectively used depending on operating frequencies of the power receiving coil 110 and the wireless communications coil 120, or a degree of overlap of the power receiving coil 110 and the wireless communications coil 120. A description thereof will be provided below in detail with reference to FIGS. 14A through 19.

FIGS. 5 through 7 illustrate one power receiving coil 110 and one wireless communications coil 120.

In one example, the power receiving coil 110 is operated according to a wireless power receiving mode operated at a frequency within the 100 kHZ to 275 kHZ band. For example, the power receiving coil 110 is operated according to either one or both of a WPC standard in the 100 kHZ to 205 kHZ band and a PMA standard operated the 235 kHZ to 275 kHZ band. For instance, the power receiving coil 100 may be operated according to the WPC standard, the PMA standard, or in a dual mode simultaneously satisfying the WPC standard and the PMA standard.

In one example, the wireless communications coil 120 is operated at 13.56 MHz according to an NFC standard.

In another example, the wireless communications coil 120 is operated at a frequency within the 60 kHZ to 80 kHZ band, and transmits the predetermined data to the magnetic card reader as in the example described above with reference to FIG. 3.

In the examples described above, the power receiving coil 110 is operated within the 100 kHZ to 275 kHZ band, and the wireless communications coil 120 is operated at 13.56 MHz according to the NFC standard or the frequency band of 60 kHZ to 80 kHZ.

In one example, the power receiving coil 110 is used for wireless communications as well as power reception.

For example, the wireless communications coil 120 is operated according to the NFC standard at 13.56 MHz. Meanwhile, the power receiving coil 110 is used for wireless power reception in the frequency band of 100 kHZ to 275 kHZ, and may also be used for data transmission at a frequency within the 60 kHZ to 80 kHZ band. This makes it possible to perform two functions using a single coil, because a frequency for receiving power and another frequency for transmitting the data are adjacent to each other.

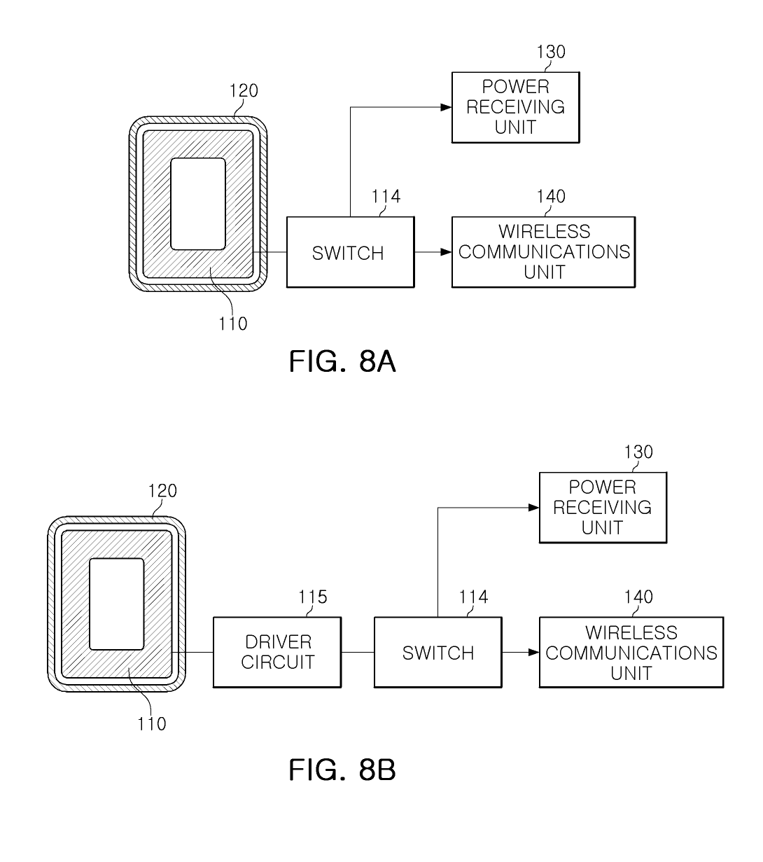

In the example described above, the power receiving coil 110 is selectively connected to one of the power receiving unit and the wireless communications unit. The example described above will be described in more detail with reference to FIGS. 8A and 8B.

FIGS. 8A and 8B are views illustrating examples of the wireless power receiving apparatus in which one coil is selectively used for power reception and wireless communications.

Referring to FIG. 8A, the power receiving coil 110 is connected to a switch 114, and the switch 114 selectively connects one of the power receiving unit 130 and the wireless communications unit 140 to the power receiving coil 110. Thus, in a case in which the power receiving unit 130 is connected to the power receiving coil 110, the power receiving coil 110 wirelessly receives power. In addition, in a case in which the wireless communications unit 140 is connected to the power receiving coil 110, the power receiving coil 110 transmits data. In one example, the wireless communications unit is operated within the 60 kHZ to 80 kHZ band, and us controlled to transmit the predetermined data to the magnetic card reader as described above.

Referring to FIG. 8B, the power receiving coil 110 is connected to a driver circuit, and the driver circuit is selectively connected to one of the power receiving unit 130 and the wireless communications unit 140. Thus, the power receiving coil 110 is operated according to a driving signal provided by the driver circuit, and the driver circuit is selectively connected to one of the power receiving unit 130 and the wireless communications unit 140 by the switch 114.

In one example, when the power receiving coil 110 is operated as the wireless power receiving coil and the wireless communications coil, the power receiving coil 110 may have a function of the wireless power receiving coil as a default. For instance, the switch 114 may have a state in which the switch 114 is connected to the power receiving unit 130 as a default setting.

In one example, a wireless power receiving operation is smoothly performed in a case in which power of a battery of the mobile terminal 10 or other electronic device connected to the wireless power receiving apparatus 100 is discharged. Thus, the power receiving coil 110 is basically operated as a wireless power receiving coil, and may be operated as a data transmitting coil if necessary (e.g., according to a switching operation of the switch 114 described above).

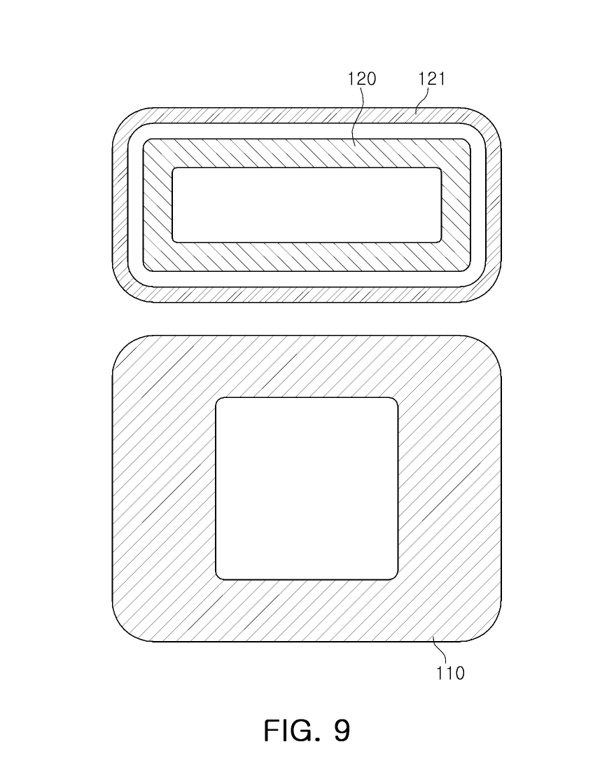

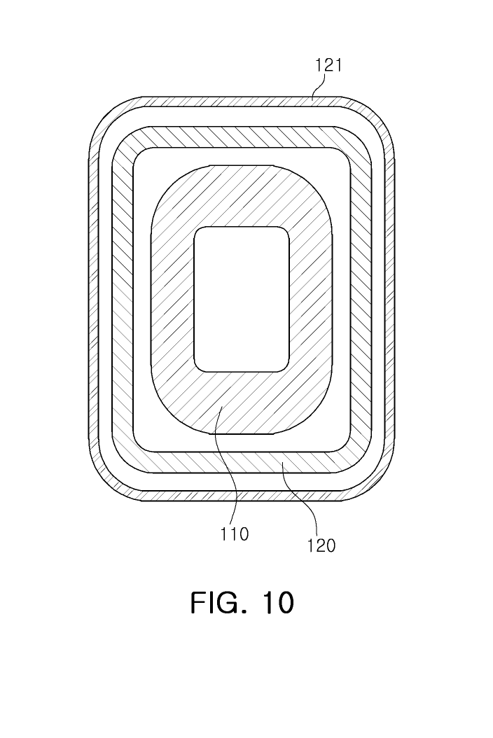

FIGS. 9 and 10 illustrate examples in which one power receiving coil 110 and two wireless communications coils 120 and 121 are provided.

FIG. 9 illustrates an example in which the power receiving coil 110 and the wireless communications coils 120 and 121 are separated from each other, and a first wireless communications coil 120 is disposed inside a second wireless communications coil 121.

The illustrated example may be applied in a case in which the power receiving coil 110 and the first wireless communications coil 120 are separated from each other because interference occurs between the power receiving coil 110 and the first wireless communications coil 120, and interference between the second wireless communications coil 121 and the power receiving coil 110 or the first wireless communications coil 120 is small.

For example, the power receiving coil 110 is operated within the 100 kHZ to 275 kHZ band, and the first wireless communications coil 120 is operated within the 60 kHZ to 80 kHZ band. The second wireless communications coil 121 is operated in a frequency band around 13.56 MHz.

Although not illustrated, since an amount of interference between the second wireless communications coil 121 and the power receiving coil 110 or the first wireless communications coil 120 is small, the second wireless communications coil 121 may be disposed inside the power receiving coil 110.

FIG. 10 illustrates an example in which one of the power receiving coil 110 and the two wireless communications coils 120 and 121 is disposed inside the other ones.

In FIG. 10, the first wireless communications coil 120 is disposed inside the second wireless communications coil 121, and the power receiving coil 110 is disposed inside the first wireless communications coil 120.

However, an arrangement relationship between three coils is not limited thereto, but may be modified according to various examples. For instance, in addition to the example in which the first wireless communications coil 120 is disposed inside the second wireless communications coil 121 and the power receiving coil 110 is disposed inside the first wireless communications coil 120, the power receiving coil 110 may be disposed inside the second wireless communications coil 121 and the first wireless communications coil 120 may be disposed inside the power receiving coil 110. Alternatively, the second wireless communications coil 121 may be disposed inside the power receiving coil 110 and the first wireless communications coil 120 may be disposed inside the second wireless communications coil 121.

In one example, the power receiving coil 110 is operated within the 100 kHZ to 275 kHZ band, and the second wireless communications coil 121 is operated at a frequency of 13.56 MHz. The first wireless communications coil 120 is operated within the 60 kHZ to 80 kHZ band.

In one example, the number of windings of the coil disposed inside is larger than that of the coil disposed outside. For instance, since a thickness of each coil is determined by the number of windings, the number of windings may be determined so that the number of windings of the power receiving coil 110 is the largest, and the number of windings of the first wireless communications coil 120 is larger than that of the second wireless communications coil 121, as illustrated in FIG. 10.

This is to allow a winding disposed inside another winding to have a larger number of windings in order to provide a sufficient coil length or inductance, because a diameter of one winding may be relatively small in a case in which the coil is disposed inside another winding.

FIG. 11 is a view of an example of a wound state of the coil structure of FIG. 10.

As illustrated in FIG. 11, the first wireless communications coil 120 is disposed inside the second wireless communications coil 121, and the power receiving coil 110 is disposed inside the first wireless communications coil 120.

In one example, the number of windings of the three coils is different from each other. For example, the number of windings of the inside first wireless communications coil 120 is larger than that of the outermost second wireless communications coil 121, and the number of windings of the inside power receiving coil 110 is larger than that of the first wireless communications coil 120.

In one example, the innermost winding 111 and the outermost winding 112 of the power receiving coil 110 have different radii of curvature. As illustrated in FIG. 11, the radius of curvature of the innermost winding 111 of the power receiving coil 110 is smaller than that of the outermost winding 112 thereof. This is to further increase an area through which flux provided by the power transmitting coil can pass by decreasing the radius of curvature of the innermost winding 111 to make an inner area of the opening part, i.e., the innermost winding 111, to be larger. In addition, a length of the winding may be adjusted by increasing the radius of curvature of the outermost winding 112. For instance, unlike the illustrated example, in a case in which the radius of curvature of the outermost winding 112 of the power receiving coil 110 is the same as the radius of curvature of the innermost winding 111, an overall length of the power receiving coil 110 will be longer than the illustrated example. Since the length of the coil influences a resistance value in addition to an inductance value, it is advantageous to reduce the resistance value by decreasing the length of the coil. Thus, the length of the power receiving coil 110 may be adjusted by adjusting the radius of curvature of the outermost winding 112 of the power receiving coil 110.

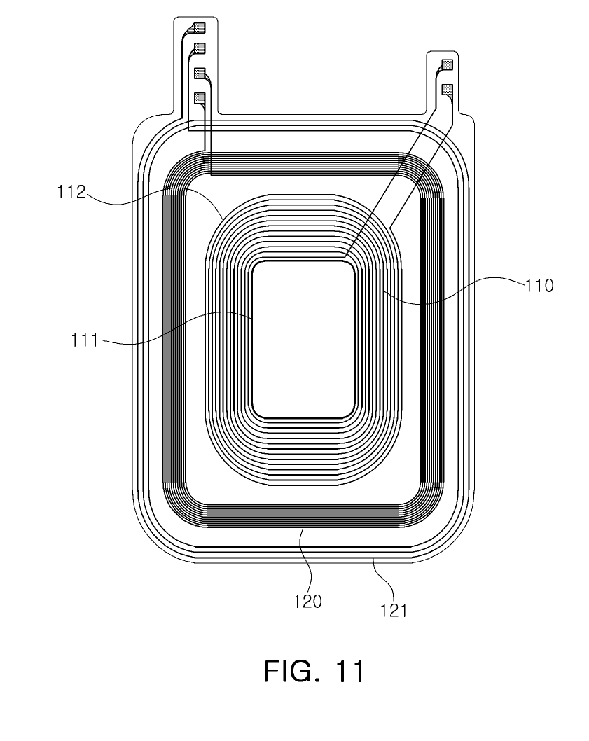

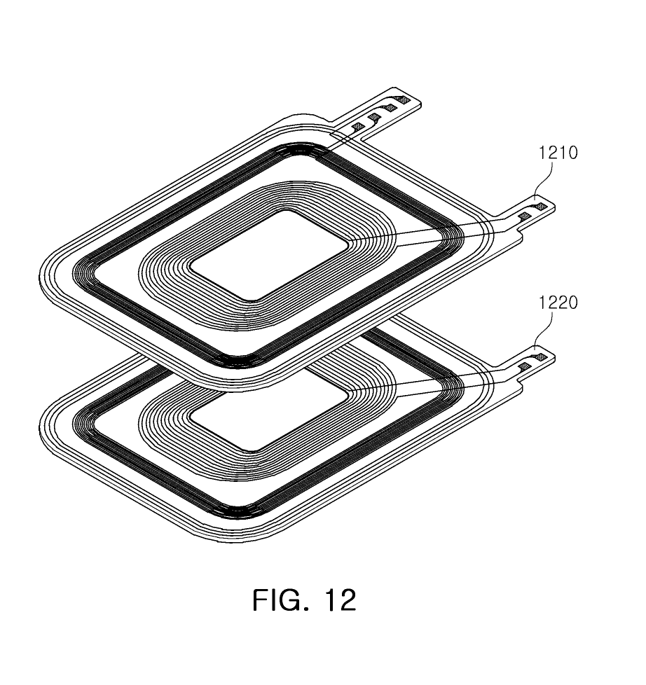

FIG. 12 is a view of an example of the coil structure of FIG. 10 formed in multiple layers.

As illustrated in FIG. 12, a plurality of coil structures of FIG. 10 are provided, and may be connected in series with each other or in parallel with each other.

As described above, since the length of the coil influences the resistance value in addition to the inductance value, the coil structures may be connected in series with each other or in parallel with each other by taking into account the above-mentioned influence.

In one example, a first power receiving coil and at least one first wireless communications coil are formed on one surface of a first substrate, and a second power receiving coil and at least one second wireless communications coil are formed on one surface of a second substrate (or the other surface of the first substrate). The first power receiving coil and the second power receiving coil may be connected in parallel with each other. This is to decrease the resistance value determined by the length of the coil while providing a required inductance value. Since this enables a stronger magnetic coupling to be obtained, an efficiency of wireless charging is increased.

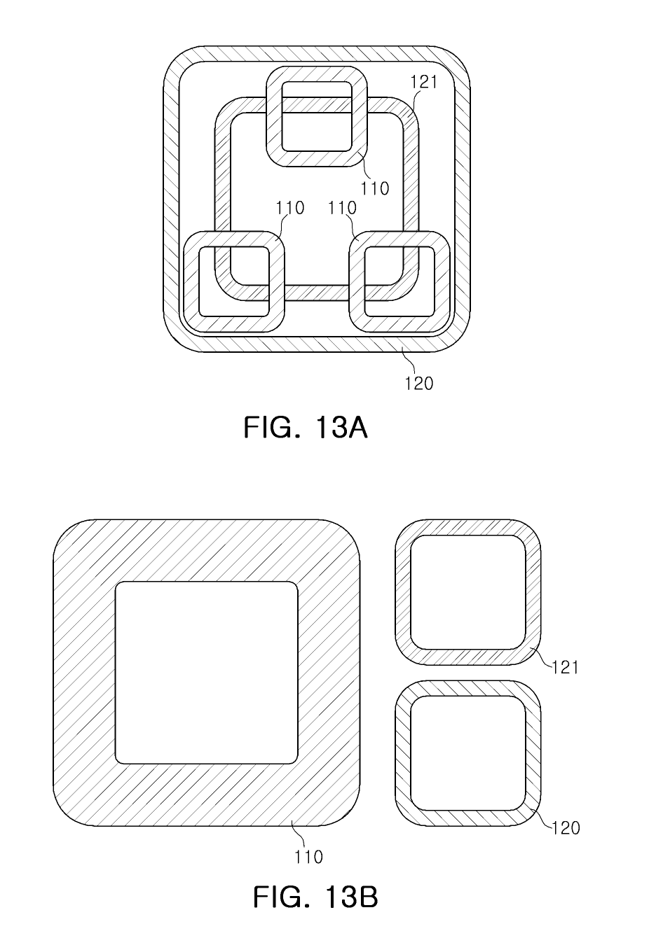

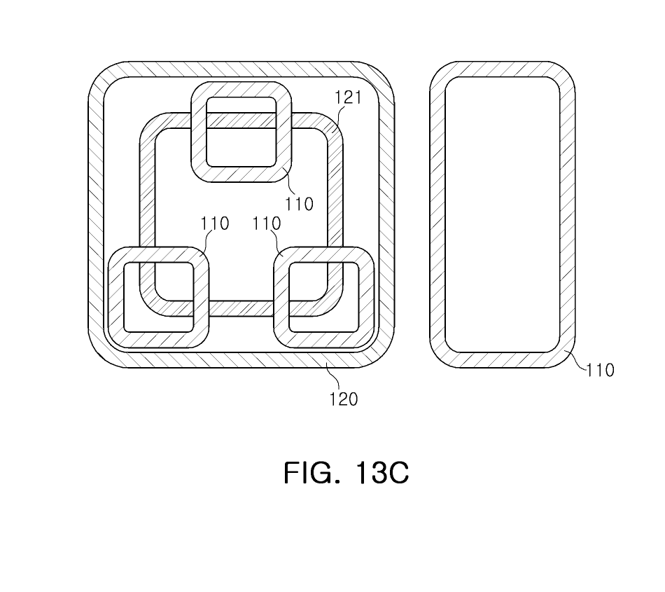

FIGS. 13A through 13C illustrate examples of various coil structures including three or more coils.

As seen from the examples of FIGS. 13A through 13C, the power receiving coil and the wireless communications coils may constitute various coil structures.

Hereinabove, various coil structures according to the present disclosure have been described with reference to FIGS. 5 through 13C. Hereinafter, various coil structures will be described in more detail with reference to FIGS. 14A through 19.

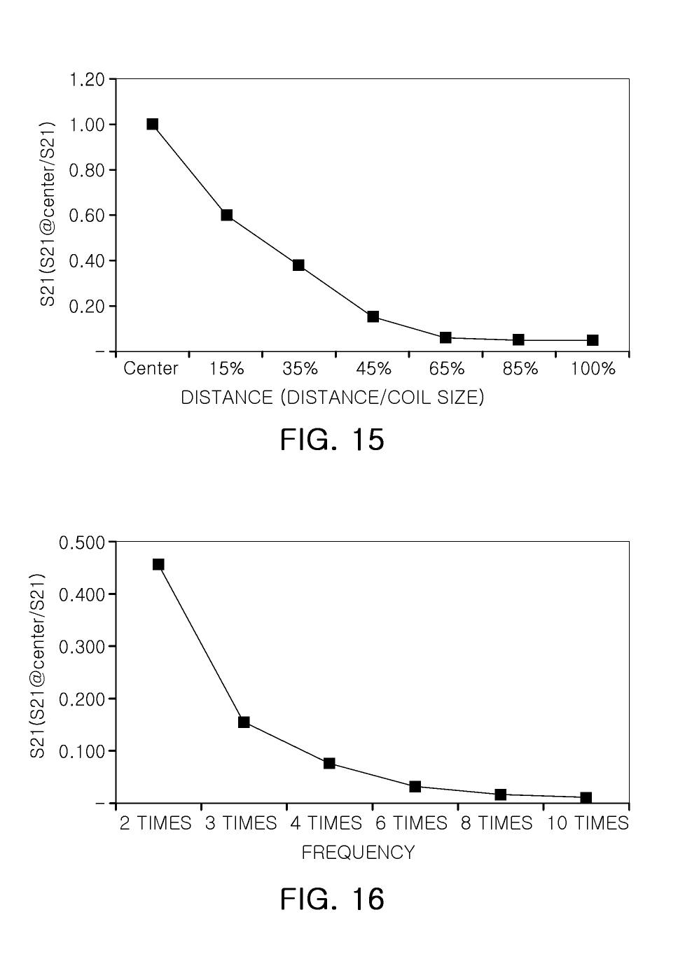

FIGS. 14A through 14D are views illustrating examples of different degrees of overlap of the power receiving coil 110 and the wireless communications coil 120 having the same size, and FIG. 15 is a graph illustrating an example of transmission efficiency according to the degrees of overlap of FIGS. 14A through 14D.

FIGS. 14A through 15 illustrate a case in which the power receiving coil 110 and the wireless communications coil 120 have a same size (e.g., 32.5 mm in width, 35 mm in height). Thus, the required inductance values of the power receiving coil 110 and the wireless communications coil 120 have a similar value.

However, although the illustrated examples illustrate a case in which the power receiving coil 110 and the wireless communications coil 120 have the same thickness, this is merely illustrative. In various examples, at least a portion of the power receiving coil 110 and the wireless communications coil 120 may have different values in the thickness, the number of windings, an inductance value, and other characteristics.

In one example, the power receiving coil 110 is operated within the 100 kHZ to 275 kHZ band. For example, the power receiving coil 110 is operated according to the WPC standard operated in the frequency band of 100 kHZ to 205 kHZ or is operated according to the PMA standard in the frequency band of 235 kHZ to 275 kHZ.

In one example, the wireless communications coil 120 is operated within the 60 kHZ to 80 kHZ band. Since the operating frequency of the wireless communications coil 120 is adjacent to the operating frequency of the power receiving coil 110, interference may occur depending on a size of an overlapped region of the power receiving coil 110 and the wireless communications coil 120.

FIG. 15 illustrates the above-mentioned interference on a Y axis as relative degrees of transmission efficiency. Since the relative degree of transmission efficiency S means a ratio of an input voltage to an output voltage on a frequency distribution, the relative degree of transmission efficiency S described below relates to a transmission efficiency between the power receiving coil 110 and the wireless communications coil 120. In addition, an X axis in FIG. 15 denotes a distance between the center P1 of the power receiving coil 110 and the center P2 of the wireless communications coil 120. For instance, ‘Center’ denotes a case in which the two centers P1 and P2 coincide, and the percentage values are ratios of a distance d between the two centers P1 and P2, such as the distances d1, d2, and d3 in FIGS. 14B through 14D, to a height of the coil.

As illustrated in FIG. 15, in a case in which the distance d between the center of the power receiving coil 110 and the center of the wireless communications coil 120 is about 60% of the height of the coil, that is, in a case in which the overlapped region is about 40% or less, it may be seen that the relative degree of transmission efficiency has a value of 0.1 or less. In addition, even in a case in which the distance d between the center of the power receiving coil 110 and the center of the wireless communications coil 120 exceeds 60% of the height of the coil, it may be seen that the relative degree of transmission efficiency has a value similar to the value described above. Thus, the case in which the two coils are spaced apart from each other so that the distance between the centers of the two coils is 60% or more of the height of the coil may be considered to have a meaning in that the interference between the two coils is decreased to be sufficiently small.

Thus, since the wireless communications coil 120 operated in a frequency band around 70 kHZ and the power receiving coil 110 operated at a frequency within the 100 kHZ to 275 kHZ band have a relative interference sufficiently small in a case in which the overlapped region with each other is 40% or less, the wireless communications coil 120 and the power receiving coil 110 have a structure in which they are overlapped with each other by 40% or less in order to effectively isolate the wireless communications coil 120 and the power receiving coil 110 from each other.

FIG. 16 is a graph illustrating an example of a transmission efficiency of the power receiving coil 110 and the wireless communications coil 120 versus frequency in a case in which the power receiving coil 110 and the wireless communications coil 120 are completely overlapped with each other as illustrated in FIG. 14A.

FIG. 16 illustrates relative degrees of the transmission efficiency versus frequency in the case in which the power receiving coil 110 and the wireless communications coil 120 have the same size as illustrated in FIGS. 14A through 14D. In the example in FIG. 16, the power receiving coil 110 is operated within the 100 kHZ to 275 kHZ band and the wireless communications coil 120 is operated at a frequency close to 70 kHZ, and FIG. 16 illustrates the transmission efficiency between the power receiving coil 110 and the wireless communications coil 120 as a frequency of the power receiving coil 110 is variably changed.

As illustrated in FIG. 16, in a case in which the operating frequency is two times, it may be seen that the transmission efficiency is about 0.45 times as compared to a case in which the operating frequencies are the same, and in a case in which the operating frequency is six times, it may be seen that the transmission efficiency is decreased to 0.05 times or less as compared to the case in which the operating frequencies are the same. Even in a case in which the operating frequency is six or more times, it may be seen that the transmission efficiency has a value similar to the case in which the transmission efficiency is 0.05 times.

Thus, in a case in which the power receiving coil 110 and the wireless communications coil 120 having the same size have the operating frequencies six or more times different from each other, since the influence of the interference to each other is small, various coil structures may be used. However, in a case in which the power receiving coil 110 and the wireless communications coil 120 have the operating frequencies six times or less different from each other, the power receiving coil 110 and the wireless communications coil 120 should have a structure in which only some regions thereof are overlapped (e.g., only an area of 40% or less is overlapped), or the power receiving coil 110 and the wireless communications coil 120 are separated from each other.

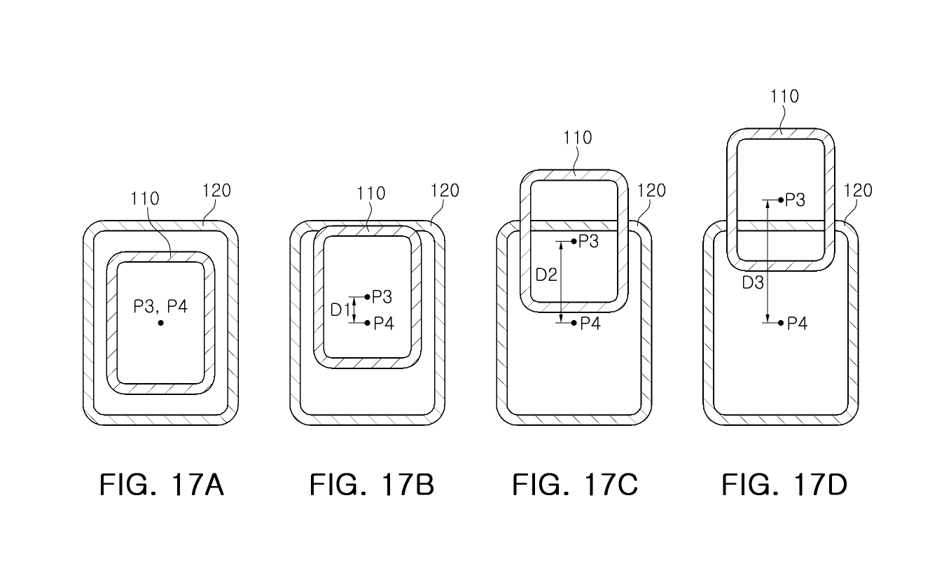

FIGS. 17A through 17D are views illustrating examples of different degrees of overlap of the power receiving coil 110 and the wireless communications coil 120 having different sizes.

Although the illustrated examples illustrates a case in which the power receiving coil 110 and the wireless communications coil 120 have the same thickness, this is merely illustrative. In various examples, at least a portion of the power receiving coil 110 and the wireless communications coil 120 may have different values in the thickness, the number of windings, an inductance value, and other characteristics.

In one example, a length of a first axis (a horizontal axis in the illustrated example) of the wireless communications coil 120 is 36 mm to 60 mm, and a length of a second axis (a vertical axis in the illustrated example) thereof is 36 mm to 120 mm. For instance, the second axis may have a length of one to two times the length of the first axis.

In one example, a length of a first axis (a horizontal axis in the illustrated example) of the power receiving coil 110 is 27 mm to 50 mm, and a length of a second axis (a vertical axis in the illustrated example) thereof is 27 mm to 100 mm. Likewise, the second axis may have a length of one to two times the length of the first axis.

In a case in which the two examples described above are applied, a ratio between the power receiving coil 110 and the wireless communications coil 120 for the first axis may have values from 0.45 at minimum to 1.38 at maximum. In addition, a ratio between the power receiving coil 110 and the wireless communications coil 120 for the second axis may have values from 0.225 at minimum to 2.7 at maximum.

In one example, a distance between the power receiving coil 110 and the wireless communications coil 120 may 2 mm at a minimum.

in one example, the power receiving coil 110 may have 10 to 14 windings, and the wireless communications coil 120 may have 7 to 9 windings. A spacing between the windings may be 0.05 mm to 2 mm.

In one example, the power receiving coil 110 may have an inductance of 7.5 μH to 9.5 pH, and the wireless communications coil 120 may have an inductance of 10 μH to 12 μH. The power receiving coil 110 may simultaneously support the WPC and the PMA.

In one example, a coil line width of the power receiving coil 110 may be thicker than that of the wireless communications coil 120. For example, the power receiving coil 110 may have a line width of 0.55 mm to 0.7 mm, and the wireless communications coil 120 may have a line width of 0.2 mm to 0.5 mm. For instance, the power receiving coil 110 may have a wider line width to be better receive the power.

In one example, a spacing between the windings of the power receiving coil 110 may be narrower than that of the wireless communications coil 120. For example, the spacing between each of a plurality of windings of the power receiving coil 110 may be 0.1 mm to 0.15 mm, and the spacing between each of a plurality of windings of the wireless communications coil 120 may be 0.15 mm or more. In one example, the winding density of the power receiving coil 110 may be denser than that of the wireless communications coil 120. Therefore, when taking account an overall area including the windings and the spacing between the windings, even though the power receiving coil 110 and the wireless communications coil 120 may have the same overall area, the number of windings of the power receiving coil 110 may be larger than that of the wireless communications coil 120.

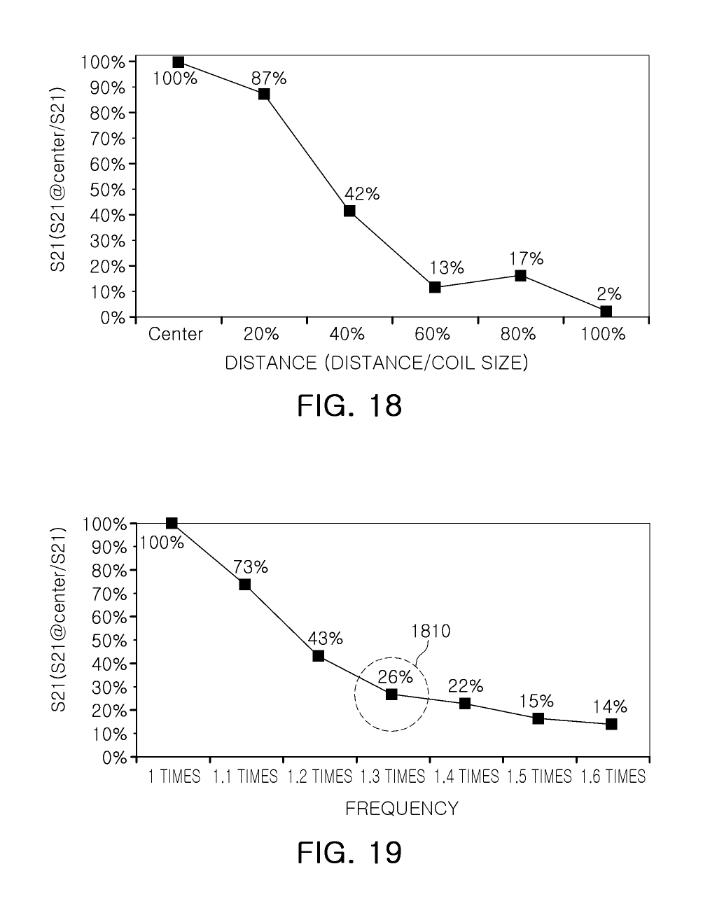

FIG. 18 is a graph illustrating examples of a transmission efficiency according to the degrees of overlap of FIGS. 17A to 17D.

The graph of FIG. 18 illustrates an example of the wireless communications coil 120 having a size of 41.8 mm in width and 51.8 mm in height, and the power receiving coil 110 having a size of 30 mm in width and 40 mm in height. In addition, the power receiving coil 110 is operated within the 100 kHZ to 275 kHZ band, and the wireless communications coil 120 is operated at a frequency close to 70 kHZ.

As illustrated in FIG. 18, in a case in which the distance d between the center of the power receiving coil 110 and the center of the wireless communications coil 120 is equal to about 60% of the height of the coil, for instance, in a case in which the overlapped region is about 40% or less, it may be seen that the relative degree of transmission efficiency has a value of about 10%.

Thus, since the wireless communications coil 120 and the power receiving coil 110 have a sufficiently low degree of relative interference in a case in which the overlapped region is 40% or less, the wireless communications coil 120 and the power receiving coil 110 should have a structure in which they are overlapped with each other by 40% or less in order to effectively isolate the wireless communications coil 120 and the power receiving coil 110 from each other.

FIG. 19 is a graph illustrating an example of the transmission efficiency of the power receiving coil 110 and the wireless communications coil 120 versus frequency in a case in which the power receiving coil 110 is disposed completely inside the wireless communications coil 120 as illustrated in FIG. 17A.

FIG. 19 illustrates relative degrees of the transmission efficiency versus frequency. In FIG. 19, the power receiving coil 110 is operated within the 100 kHZ to 275 kHZ band and the wireless communications coil 120 is operated at a frequency of 70 kHZ, and FIG. 19 illustrates an example of the transmission efficiency between the power receiving coil 110 and the wireless communications coil 120 as a frequency of the power receiving coil 110 is changed.

As illustrated in FIG. 19, in a case in which a ratio of a frequency of the wireless communications coil 120 to a frequency of the power receiving coil 110 is 1.3:1, a relative degree of transmission efficiency S21 is about 26% (reference numeral 1810). The relative degree of transmission efficiency of 26% corresponds to about −6 dB.

For instance, in a case in which the frequency of the wireless communications coil 120 is equal to 1.3 or more times the frequency of the power receiving coil 110, since the relative degree of transmission efficiency has a value of −6 dB or less, a state in which an influence due to the interference of the two coils is low, that is, a good state, may be achieved. Thus, the operating frequencies thereof having a difference of 1.3 or more times as described above may be considered to have a meaning as a good interference threshold.

In one example, in the case in which the operating frequency of the wireless communications coil 120 is equal to 1.3 or more times that of the operating frequency of the power receiving coil 110, the wireless power receiving apparatus may use a coil structure in which the power receiving coil 110 and the wireless communications coil 120 are separated and spaced apart from each other (e.g., the examples of FIGS. 5 and 9), and a coil structure in which the power receiving coil 110 is disposed inside the wireless communications coil 120 (e.g., the examples of FIGS. 7 and 10).

In one example, in the case in which the operating frequency of the wireless communications coil 120 is less than 1.3 times that of the power receiving coil 110, the wireless power receiving apparatus should use the coil structure in which the power receiving coil 110 and the wireless communications coil 120 are separated and spaced apart from each other (e.g., the examples of FIGS. 5 and 9).

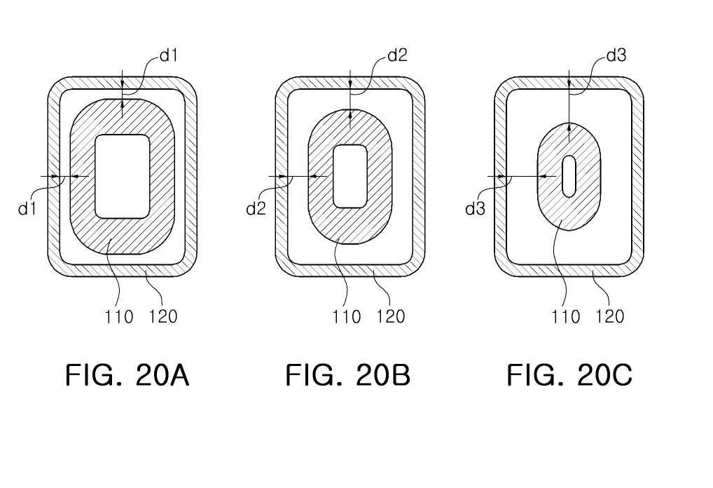

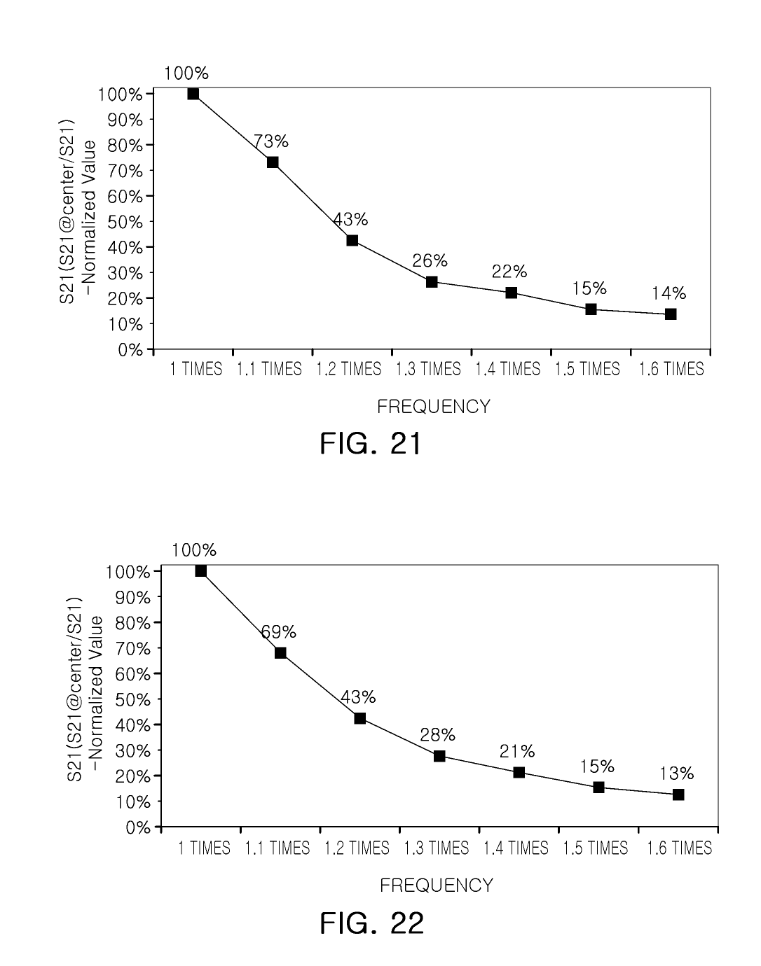

FIGS. 20A through 20C are views illustrating examples of a distance between the power receiving coil and the wireless communications coil, and FIGS. 21 through 23 are graphs illustrating examples of a relative degree of transmission efficiency versus frequency for the examples of FIGS. 20A through 20C.

FIG. 20A illustrates an example in which a distance d1 between the power receiving coil 110 and the wireless communications coil 120 is 2 mm, FIG. 20B illustrates an example in which a distance d2 between the power receiving coil 110 and the wireless communications coil 120 is 4 mm, and FIG. 20C illustrates an example in which a distance d3 between the power receiving coil 110 and the wireless communications coil 120 is 6 mm.

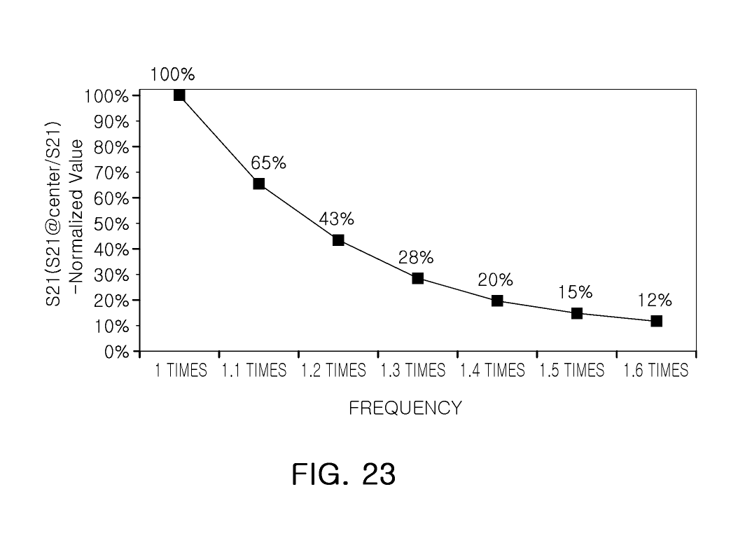

FIG. 21 is a graph illustrating relative degrees of transmission efficiency versus frequency for FIG. 20A, FIG. 22 is a graph illustrating relative degrees of transmission efficiency versus frequency for FIG. 20B, and FIG. 23 is a graph illustrating relative degrees of transmission efficiency versus frequency for FIG. 20C.

As commonly seen from FIGS. 21 through 23, in a case in which a ratio of a frequency of the wireless communications coil 120 to a frequency of the power receiving coil 110 is 1.3:1, it may be seen that the relative degree of transmission efficiency S21 is 26% to 28%. Since the relative degree of transmission efficiency of 26% corresponds to about −6 dB, this value may be considered to have a meaning that it has a low interference, as described above.

Thus, even in a case in which the distance between the power receiving coil 110 and the wireless communications coil 120 is 2 mm to 6 mm, if the ratio of the frequency of the wireless communications coil 120 to the frequency of the power receiving coil 110 is 1.3:1 or more, mutual interference of the power receiving coil 110 and the wireless communications coil 120 may be low. As a result, it may be seen that one coil may be disposed inside another coil, or two coils may be disposed so that only at least some portions thereof are overlapped with each other without separating the two coils from each other.

Hereinabove, various coil structures or the wireless power receiving apparatus have been described with reference to FIGS. 1 through 23.

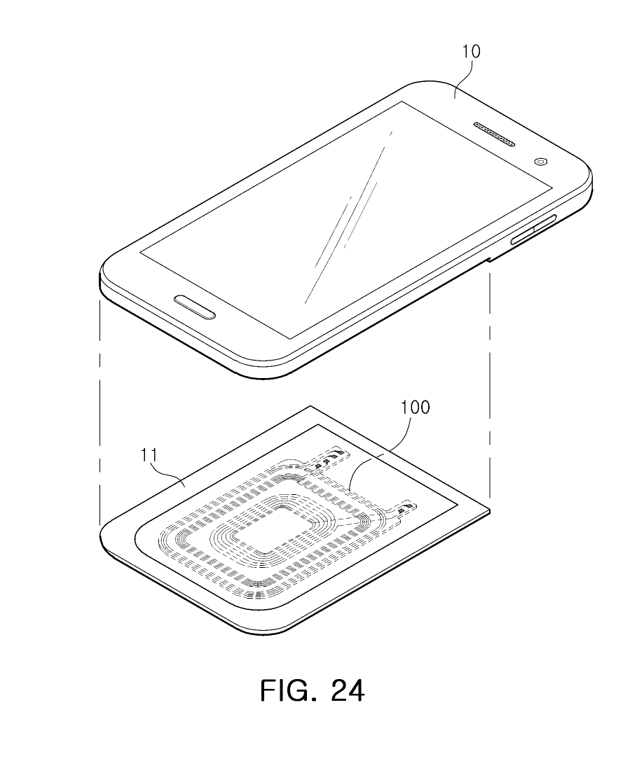

Hereinafter, various examples to which the coil structures or the wireless power receiving apparatus described above may be applied will be described with reference to FIGS. 24 through 27.

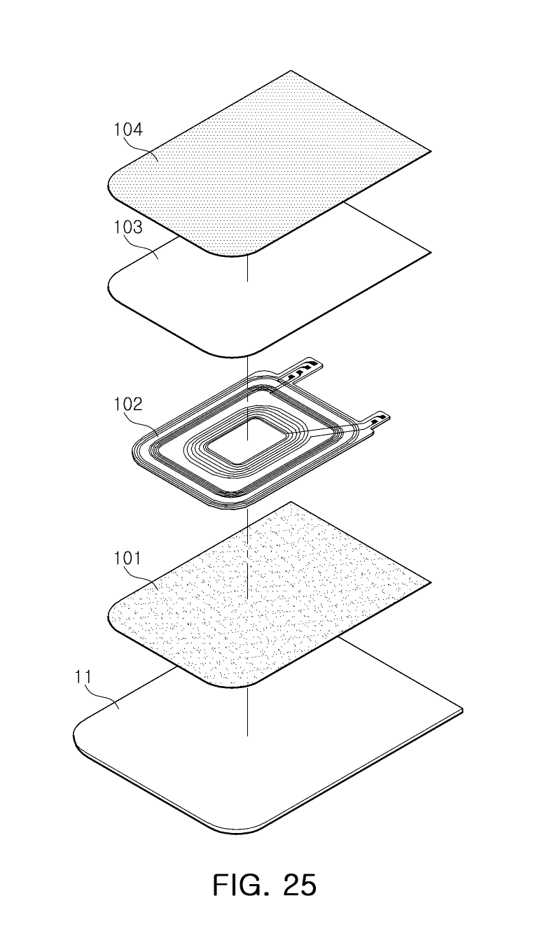

FIG. 24 is a perspective view illustrating an example of a cover for a mobile terminal, and FIG. 25 is an exploded perspective view of the cover for the mobile terminal illustrated in FIG. 24. FIGS. 24 and 25 illustrate one example of a cover for a mobile terminal to which the coil structure or the wireless power receiving apparatus is applied.

Referring to FIGS. 24 and 25, a cover 11 for a mobile terminal may be coupled to a mobile terminal 10. The cover 11 for the mobile terminal includes the coil structure or the wireless power receiving apparatus.

In one example, the cover 11 for the mobile terminal includes a cover housing 11, a coil structure 102, and a magnetic sheet 103. In one example, the cover 11 for the mobile terminal may further include either one or both of an adhesive sheet 101 and a heat dissipating sheet 104.

The coil structure 102 is fixed to an internal surface of the cover housing. For example, the adhesive sheet 101 may fix the coil structure 102 to the internal surface of the cover housing.

As the coil structure 102, various coil structures described above with reference to FIGS. 5 through 13C may be applied.

In one example, the coil structure 102 includes a first coil configured to transmit or receive a first signal of a first frequency and a second coil configured to transmit or receive a second signal of a second frequency. The second coil is disposed inside or outside of the first coil, and a ratio of the second frequency to the first frequency is 1.3:1 or more.

In one example, the coil structure 102 includes a first wireless communications coil operated at a frequency within the 60 kHZ to 80 kHZ band, and a second wireless communications coil separated from the first wireless communications coil and supporting wireless communications in an NFC scheme.

In another example, the coil structure 102 includes the first wireless communications coil operated at a frequency within the 60 kHZ to 80 kHZ band, the second wireless communications coil separated from the first wireless communications coil and supporting the wireless communications in the NFC scheme, and a power receiving coil disposed inside the first wireless communications coil and operated at a frequency within the 100 kHZ to 275 kHZ band.

In one example, the magnetic sheet 103 is provided on an upper surface of the fixed coil structure 102. The magnetic sheet 103 allows magnetic flux to be smoothly induced into the coil structure 102.

In one example, the heat dissipating sheet 104 is provided on an upper surface of the magnetic sheet 103 to provide a heat dissipating function.

Although not illustrated, the cover 11 for the mobile terminal may further include a predetermined power receiving unit (e.g., a control IC for power reception) for wirelessly receiving power. The power receiving unit is electrically connected to at least one of a plurality of coils of the coil structure 102 to receive the power wirelessly provided by an external power source.

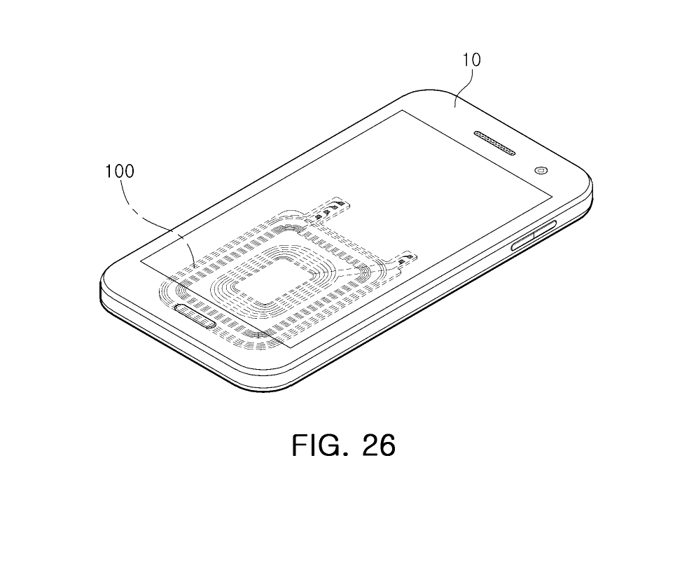

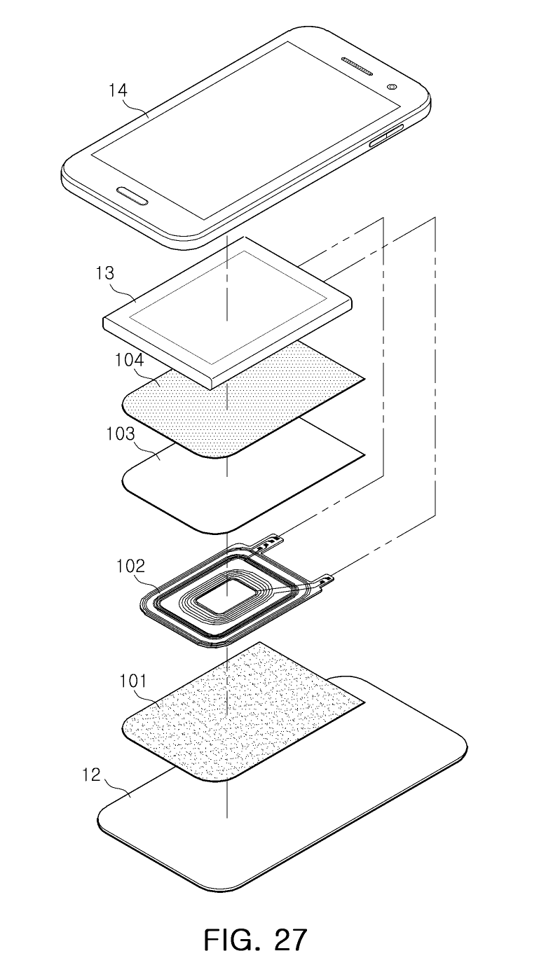

FIG. 26 is a perspective view illustrating an example of a mobile terminal, and FIG. 27 is an exploded perspective view of the mobile terminal illustrated in FIG. 26. FIGS. 26 and 27 illustrate one example of a mobile terminal to which the coil structure or the wireless power receiving apparatus is applied.

Referring to FIGS. 26 and 27, the mobile terminal 10 includes the coil structure or the wireless power receiving apparatus 100.

The mobile terminal 10 includes a rear housing 12, a coil structure 102 provided on the rear housing, and a body part 14.

The body part 14 is coupled to the rear housing 12 to constitute the mobile terminal 10. The body part 14 includes various mechanical or electrical components for performing a function of the mobile terminal 10, and this application does not particularly limit the body part 14 of the mobile terminal 10.

The coil structure 102 is electrically connected to a battery 13 of the mobile terminal. For example, the coil structure 102 includes a plurality of coils, and at least one of the plurality of coils is a wireless power receiving coil. The wireless power receiving coil is electrically connected to the battery 13 of the mobile terminal, and power wirelessly received by the wireless power receiving coil is provided to the battery 13.

The coil structure 102 is fixed to an internal surface of the rear housing 12. For example, the adhesive sheet 101 may fix the coil structure 102 to the internal surface of the rear housing 12.

As the coil structure 102, various coil structures described above with reference to FIGS. 5 through 13C may be applied.

In one example, the coil structure 102 includes a first coil configured to transmit or receive a first signal of a first frequency and a second coil configured to transmit or receive a second signal of a second frequency. The second coil is disposed inside or outside of the first coil, and a ratio of the second frequency to the first frequency may be 1.3:1 or more.

In one example, the coil structure 102 includes a first wireless communications coil operated at a frequency within the 60 kHZ to 80 kHZ band, and a second wireless communications coil separated from the first wireless communications coil and supporting wireless communications of an NFC scheme.

The magnetic sheet 103 and the heat dissipating sheet 104 may be easily understood from the contents described with reference to FIGS. 24 and 25.

As set forth above in the various examples, the power or the data may be stably transmitted or received by adjusting interference between the plurality of coils.

Damage that may be caused in the second coil of an inactive state or the electronic circuit connected to the second coil may be prevented by the first coil of the active state.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil structure comprising:
a first coil configured to transmit or receive a first signal of a first frequency; and
a second coil configured to transmit or receive a second signal of a second frequency;
wherein the second coil is disposed outside the first coil; and
a ratio of the second frequency to the first frequency is at least 1.3:1.

2. The coil structure of claim 1, wherein the first coil is a power receiving coil configured to operate at a frequency within a 100 kHZ to 275 kHz band; and
the second coil is a wireless communications coil configured to operate at a frequency within 60 kHZ to 80 kHZ band.

3. The coil structure of claim 1, wherein the first coil comprises a plurality of windings; and
a radius of curvature of an outermost winding of the first coil is greater than a radius of curvature of an innermost winding of the first coil.

4. The coil structure of claim 1, wherein the first coil is spaced apart from the second coil by a distance of 2 mm to 6 mm.

5. The coil structure of claim 1, wherein a number of windings of the first coil is larger than a number of windings of the second coil.

6. The coil structure of claim 1, wherein the first coil has 10 to 14 windings;
the second coil has 7 to 9 windings; and
a distance between the windings of each of the first coil and the second coil is 0.05 mm to 2 mm.

7. The coil structure of claim 1, wherein the first coil has a first axis having a length of 27 mm to 50 mm, and a second axis having a length of 27 mm to 100 mm; and
the second coil has a first axis having a length of 36 mm to 60 mm, and a second axis having a length of 36 mm to 120 mm.

8. The coil structure of claim 1, wherein the first coil has an inductance of 7.5 μH to 9.5 μH; and
the second coil has an inductance of 10 μH to 12 μH.

9. The coil structure of claim 1, wherein the first coil has a line width of 0.55 mm to 0.7 mm; and
the second coil has a line width of 0.2 mm to 0.5 mm.

10. The coil structure of claim 1, further comprising a third coil disposed outside the first coil and the second coil;
wherein the third coil is configured to support wireless communications in a near field communication (NFC) scheme.

11. A wireless power receiving apparatus comprising:
a first coil configured to operate as a power receiving coil and a wireless communications coil, the first coil being configured to receive a signal of a first frequency as the power receiving coil, and transmit or receive a signal of a second frequency as the wireless communications coil; and
a second coil configured to transmit or receive a signal of a third frequency different from the first frequency and the second frequency;
wherein at least part of the second coil is disposed outside the first coil.

12. The wireless power receiving apparatus of claim 11, further comprising:
a power receiving unit configured to wirelessly receive power using the first coil;
a wireless communications unit configured to wirelessly transmit or receive data using the first coil; and
a switch configured to selectively connect the first coil to the power receiving unit to enable the power receiving unit to wirelessly receive power using the first coil, and selectively connect the first coil to the wireless communications unit to enable the wireless communications unit to wirelessly transmit or receive data using the first coil.

13. The wireless power receiving apparatus of claim 12, wherein the switch is further configured to connect the first coil to the power receiving unit as a default setting.

14. The wireless power receiving apparatus of claim 11, further comprising:
a driver circuit connected to the first coil;
a power receiving unit;
a wireless communications unit; and
a switch configured to selectively connect the driver circuit to the power receiving unit to enable the power receiving unit to wirelessly receive power using the driver circuit and the first coil, and selectively connect the driver circuit to the wireless communications unit to enable the wireless communications unit to wirelessly transmit or receive data using the driver circuit and the first coil.

15. The wireless power receiving apparatus of claim 11, wherein the second coil has a same size as the first coil; and
a distance between a center of the first coil and a center of the second coil is at least 60% of a height of the first coil.

16. The wireless power receiving apparatus of claim 15, wherein the first coil is configured to operate as the power receiving coil at a frequency within a 100 kHZ to 275 kHz band; and
the second coil is a wireless communications coil configured to operate at a frequency within a 60 kHZ to 80 kHZ band.
